(19) United States
(12) Patent Application Publication
(10) Pub. No.: US 2015/0235749 A1
(43) Pub. Date: Aug. 20, 2015

(54) MAGNETIC CORE

(71) Applicant: Delta Electronics (Shanghai) Co., Ltd., Shanghai (CN)

(72) Inventors: Zhi HUANG, Shanghai (CN); Zhao-Hui WANG, Shanghai (CN); Wei ZHANG, Shanghai (CN); Ju-Ming HU, Shanghai (CN)

(21) Appl. No.: 14/309,907

(22) Filed: Jun. 20, 2014

(30) Foreign Application Priority Data
Feb. 14, 2014 (CN) 201410051687.1

(51) Int. Cl. H01F 3/02; H01F 27/28; H01F 3/08

(52) U.S. Cl. CPC H01F 3/02; H01F 3/08; H01F 27/2823

(57) ABSTRACT

A magnetic core utilized in a reactor includes an upper yoke, a bottom yoke, and at least two core columns. The closed magnetic loop is formed by the upper yoke, the bottom yoke, and the core columns. The core columns include at least one first magnetic column. The first magnetic column includes a core body, a balance magnetic unit and an air gap. The balance magnetic unit and the adjacent air gap form a composite air gap for dividing the first magnetic column into different parts. The upper yoke, the bottom yoke, and the two core columns constitute a closed magnetic loop. The composite air gap is disposed at a side of the core body. The upper yoke, the bottom yoke, and the core body are made of planar laminated magnetic material. The magnetic permeability of the balance magnetic unit is lower than which of the planar laminated magnetic material.

### RELATED APPLICATIONS

This application claims priority to Chinese Application Serial Number 2014100516871, filed Feb. 14, 2014, which is herein incorporated by reference.

### BACKGROUND

1. Field of Invention

The present invention relates to a magnetic core. More particularly, the present invention relates to a magnetic core utilized in a reactor.

2. Description of Related Art

In the current application of the high power transformer, the reactor is usually utilized to restrain the current ripple and improve power factors. With the development of the switch device, the frequency of the switch becomes higher. More particularly, when the frequency of the switch is higher than 5 kHz, conventionally, the reactor of silicon steel sheet with air gap is utilized. Because of the greater loss and lower efficiency of the reactor, the silicon steel sheet becomes inadequate for the reactor. Therefore, two new composite materials used for the core of the reactor are developed: one is the material stacked by block cores of metal powder; the other is the material stacked by planar laminated magnetic material. The air gap is necessary for both magnetic cores above.

Each of the reactors above possesses different advantage. Because the stacked block cores of metal powder have distributed air gap, the reactor may reduce the high-frequency eddy loss efficiently, be softly saturated, and effectively respond to some special situations, that is, the instantaneous pulse current, over loading operation and so on. However, because the planar laminated magnetic material with air gap has lower magnetic core loss and higher saturation flux density, the reactor may have smaller size and contains less copper. Comparatively, the planar laminated magnetic material has concentrated air gap, it may increase the loss of the coil significantly, and the diffusion magnetic flux induced by the air gap may cut the flux of the planar laminated magnetic material so that the core eddy loss of the reactor is increased.

Even the diffusion magnetic flux of the planar laminated magnetic material results in greater eddy loss of the coil and core, the usage of copper coil and magnetic core is relatively less so that the total loss of the reactor is substantially equal to that of the reactor of metal powder core. Although the reactor made of the stacked block cores of meta powder has greater volume, the inductance for light load of the reactor is greater than that of the reactor of the planar laminated magnetic material owing to the soft saturation. Therefore, it is not easy for the designer to choose any one from both.

### SUMMARY

This invention provides a magnetic core of composite material which meets the need of small volume, loss reduction and eddy current reduction.

One embodiment of this invention provides a magnetic core utilized in a reactor. The magnetic core includes an upper yoke, a bottom yoke, and at least two core columns. The core columns include at least one first magnetic column. The first magnetic column includes a core body, a balance magnetic unit and an air gap. The balance magnetic unit and the adjacent air gap form a composite air gap for dividing the first magnetic column into different parts. the upper yoke, the bottom yoke, and the two core columns essentially constitute a closed magnetic loop. The composite air gap is disposed at a side of the core body. The upper yoke, the bottom yoke, and the core body are made of planar laminated magnetic material. The magnetic permeability of the balance magnetic unit is lower than the magnetic permeability of the planar laminated magnetic material.

In one or more embodiments of this invention, the initial magnetic permeability of the balance magnetic unit is not greater than one twentieth of that of the planar laminated magnetic material.

In one or more embodiments of this invention, the balance magnetic unit is a kind of block core of metal powder. In one or more embodiments of this invention, the material of the block core of metal powder is ferrosilicon, Al—Si—Fe alloy, ferronickel alloy, nickel-molybdenum iron, amorphous alloy, nano-crystalline alloy, or silicon steel lamination.

In one or more embodiments of this invention, the ratio of the thickness of the balance magnetic unit and the thickness of the air gap is essentially in the range of 4 to 20.

In one or more embodiments of this invention, the quantity of the balance magnetic units in each of the composite air gaps is one or two.

In one or more embodiments of this invention, the balance magnetic units or the balance magnetic unit is symmetrically arranged according to the center line of the composite air gap. In one or more embodiments of this invention, the magnetic core includes a magnetic isolated material filled in the air gap. The magnetic permeability of the magnetic isolated material is one.

In one or more embodiments of this invention, the planar laminated magnetic material may be amorphous alloy, nano-crystalline alloy, permalloy, silicon steel lamination or super silicon steel lamination.

In one or more embodiments of this invention, the upper yoke, the bottom yoke, and the core body are made by winding and cutting a thin alloy belt.

In one or more embodiments of this invention, the upper yoke, the bottom yoke, and the core body are made by cutting and laminating a thin alloy belt.

In one or more embodiments of this invention, the composite air gaps are plural and uniformly distributed on the first magnetic column.

In one or more embodiments of this invention, two core columns are both the first magnetic columns.

In one or more embodiments of this invention, the cross-section of the first magnetic column is rectangular.

In one or more embodiments of this invention, the core columns include a second magnetic column. The cross-section area of the second magnetic column is smaller than that of the first magnetic column.

In one or more embodiments of this invention, the second magnetic column is formed of planar laminated magnetic material.

Another embodiment of this invention is a reactor including said magnetic core and a coil. The coil is winded on the first magnetic column.

In one or more embodiments of this invention, the coil is a square wire.

The magnetic core of this invention possesses the advantages of small volume of planar laminated magnetic material and high saturating current. It also reduces the eddy loss of the coil and that of the magnetic core so that it possesses the advantage of balancing the inductance under light-heavy load as the block core of metal powder.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view of the magnetic core according to one embodiment of this invention;

FIG. 2 is a curve diagram showing the relation between the magnetic flux and magnetic field (B-H) for the reactor with different magnetic core;

FIG. 3 and FIG. 4 are curve diagrams showing a magnetic permeability versus intensity of magnetic field (u-H) for the reactor with different magnetic core;

FIG. 5A is a schematic view of the magnetic flux for the core column of planar laminated magnetic material;

FIG. 5B is a schematic view of the magnetic flux for the core column of planar laminated magnetic material with a balance magnetic unit;

FIG. 6 is partial enlarged view of a magnetic core according to one embodiment of this invention;

FIG. 7 is specific loss diagram showing the magnetic cores with the balance magnetic unit of different ratio;

FIG. 8 and FIG. 9 are partial enlarged views of the magnetic core according to different embodiments of this invention;

FIG. 10 is a schematic view of the magnetic core according to another embodiment of this invention;

FIG. 11 is a schematic view of the reactor with the magnetic core according to one embodiment of this invention;

FIG. 12 is a schematic view of the reactor with the magnetic core according to another embodiment of this invention;

FIG. 13 is a schematic view of the reactor with the magnetic core according to further another embodiment of this invention;

FIG. 14 is a diagram showing the relation between the inductance and the ampere-turn for the conventional reactor with the magnetic core of single material and the reactor in FIG. 13; and

FIG. 15 is a schematic view of the reactor with the magnetic core according to yet another embodiment of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

This invention provides a magnetic core of composite material. When the magnetic core is utilized in a reactor, the magnetic core possesses the advantages of small volume of planar laminated magnetic material and high saturating current. It also reduces the eddy loss of the coil and that of the magnetic core so that it possesses the advantage of balancing the inductance under light-heavy load as the block core of metal powder.

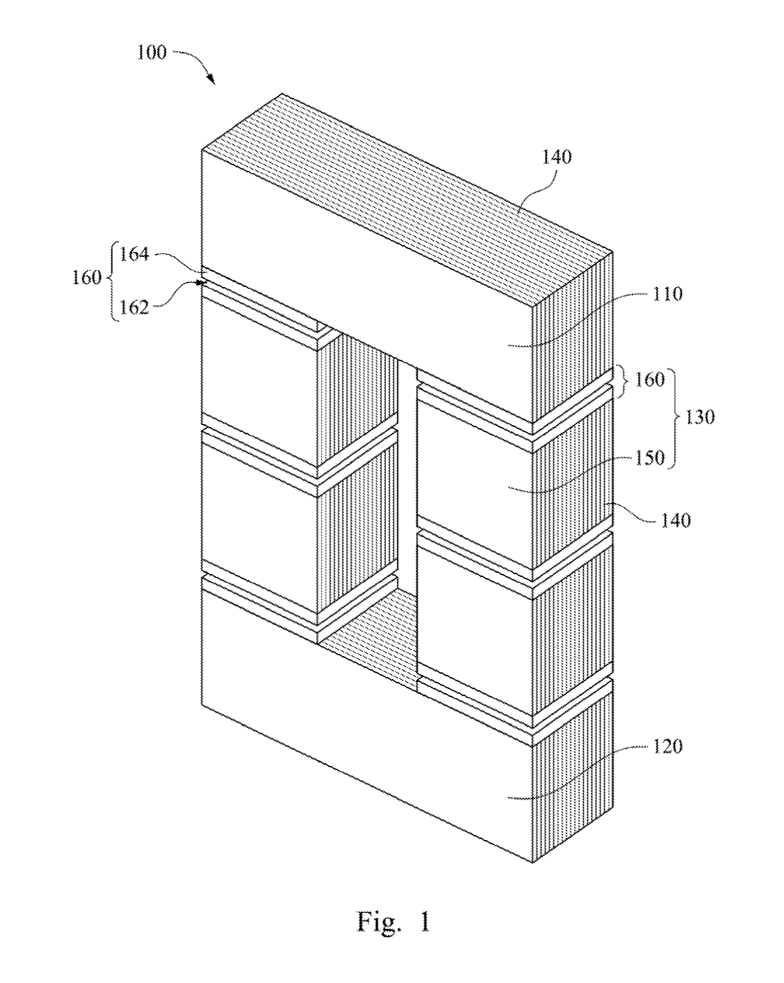

Referring to FIG. 1, FIG. 1 is a schematic view of the magnetic core according to one embodiment of this invention. The magnetic core 100 may be utilized in a reactor. The magnetic core 100 includes an upper yoke 110, a bottom yoke 120, and at least two core columns. The closed magnetic loop is essentially formed by the upper yoke 110, the bottom yoke 120, and the core columns. The upper yoke 110 and the bottom yoke 120 are made of planar laminated magnetic material 140. The two ends of the core column are connected to the upper yoke 110 and the bottom yoke 120 respectively.

In this embodiment, two core columns are both the first magnetic columns 130. The first magnetic column 130 includes a core body 150, an air gap 162 and a balance magnetic unit 164. The balance magnetic unit 164 and the adjacent air gap 162 form a composite air gap 160 which divides the core body 150 into different parts. The core body 150 is made of the planar laminated magnetic material. The magnetic permeability of the balance magnetic unit 164 is lower than the magnetic permeability of the planar laminated magnetic material. The initial magnetic permeability of the balance magnetic unit 164 is not greater than one twentieth of that of the planar laminated magnetic material 140.

Each of the composite air gaps 160 includes at least one air gap 162 and at least one balance magnetic unit 164. The air gap 162 and the balance magnetic units 164 which are adjacent to each other are disposed along the direction of the magnetic path of the magnetic core 100. The material filled in the air gaps 162 has the permeability substantially the same as the one of the air. The material of the balance magnetic unit 164 is one kind of the block core of metal powder.

In this embodiment, the quantity of the first magnetic columns 130 is two. The first magnetic columns 130, the upper yoke 110 and the bottom yoke 120 constitute a rectangle which is essentially a kind of a closed magnetic loop. The magnetic path direction of the magnetic core 100 could be from the upper yoke 110 through the first magnetic column 130, the bottom yoke 120, the other first magnetic column 130 and back to the upper yoke 110 circularly. In this embodiment, the quantity of the composite air gaps 160 is six. The composite air gaps 160 are distributed on the first magnetic columns 130 uniformly. The cross-section of the first magnetic columns 130 is rectangular.

The quantity of the balance magnetic units 164 in each of the composite air gaps 160 is one or two. The balance magnetic units 164 are arranged symmetrically according to center line of the composite air gap 160.

The planar laminated magnetic material 140 may be amorphous alloy, nano-crystalline alloy, perm alloy, silicon steel lamination or super silicon steel lamination and so on. The upper yoke, the bottom yoke, and the core body are made by cutting a wounded thin alloy belt. Alternatively, the upper yoke, the bottom yoke, and the core body are may be made by cutting the alloy laminations and laminating them.

The material of the balance magnetic unit 164 is a kind of block core of metal powder. The material of the block core of metal powder may be, for example, ferrosilicon, Al—Si—Fe alloy, ferronickel alloy, nickel-molybdenum iron, amorphous alloy, nano-crystalline alloy, or silicon steel lamination. The initial permeability of the block core of metal powder is about in the range of 26 to 300.

The composite air gap 160 further includes a magnetic isolated material filled in the air gap 162. The magnetic isolated material may be made of a non-conductive and magnetic non-permeable material, for example, an isolating plate, a ceramic sheet, foam material, glass, isolating tape, etc. The permeability of the magnetic isolated material is one and the same as the air.

In the same specifications of current and inductance, the magnetic core of the planar laminated magnetic material may have smaller volume, while inductance of reactor made by the magnetic core is lower than the one made by block core of metal powder under the condition of light load. Comparably, although the magnetic core of block core of metal powder has better performance under the condition of light load, the volume of the magnetic core should increase in order to match the specification of inductance thereof for heavy load.

According to this invention, the magnetic core of composite material utilized in the reactor may possess the advantages both of the planar laminated magnetic material and the block core of metal powder. That is, the magnetic core with small volume has good inductance for both light and heavy load. Furthermore, the magnetic flux of the magnetic path in the magnetic core of composite material may be determined by the formula as below:

$$φ = \frac{NI}{Rp + R 1 + Rg} ,$$

where NI is the ampere turns of the reactor; Rp is the magnetic resistance of the balance magnetic unit 164; R1 is the magnetic resistance of the planar laminated magnetic material 140; and Rg is the magnetic resistance of the air gap. When the ampere turns NI of the reactor increases gradually, the magnetic resistance Rg of the air gap 162 is fixed basically and the magnetic resistance Rp of the balance magnetic unit 164 increases slowly. Meanwhile, because the balance magnetic unit 164 may share part of the magnetomotive force, the magnetic resistance R1 of the planar laminated magnetic material 140 increases more slowly than that without the balance magnetic unit 164. Therefore, the total magnetic resistance increases slowly, that is, it needs more ampere turns to achieve higher magnetic flux so that the ability of anti-saturation for the reactor is improved.

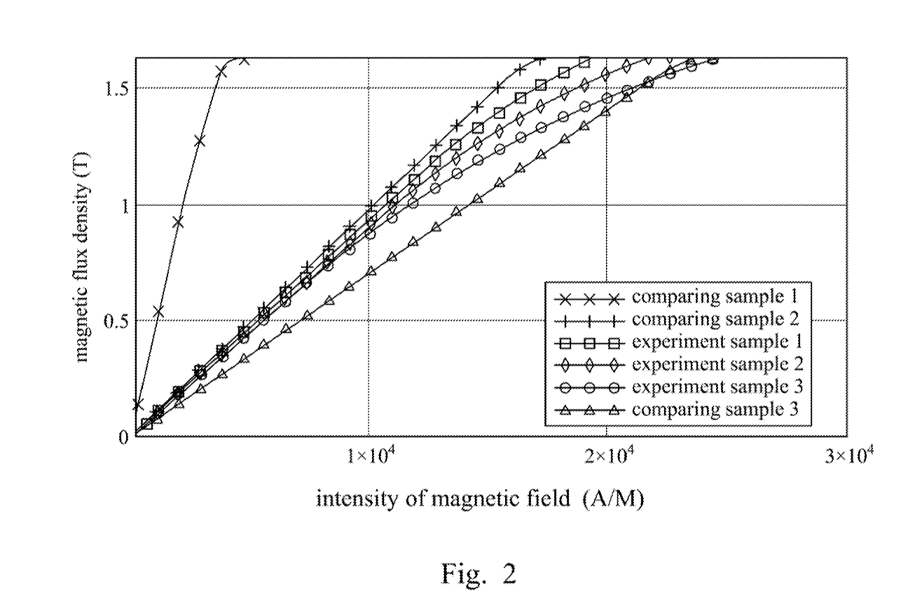

Referring to FIG. 2, FIG. 2 is a curve diagram showing the relation between the magnetic flux density and the magnetic field (B-H) for the reactor with different magnetic core. In FIG. 2, the horizontal axis shows the magnetic field H, and the unit is Ampere/Meter (A/M). The vertical axis shows the magnetic flux density B, and the unit is Tesla (T). For the comparing samples 1-3 and experiment samples 1-3, the magnetic cores of them have substantially the same size and the same length of the magnetic path. The magnetic core of comparing sample 1 is made of the planar laminated magnetic material, that is, the magnetic core of single material, and is without air gap. The magnetic core of comparing sample 2 is made of the planar laminated magnetic material, that is, the magnetic core of single material, and has air gaps. The total length of the air gaps is equal to 1% of the magnetic path. The magnetic core of comparing sample 3 is made of the planar laminated magnetic material, that is, the magnetic core of single material, and has air gaps. The total length of the air gaps is equal to 1.5% of the magnetic path. The magnetic cores of experiment samples 1-3 are the magnetic core of composite material in this invention. The total length of the air gaps for the experiment sample 1 is equal to 1% of the magnetic path and the total length of the balance magnetic units is equal to 3% of the magnetic path. The total length of the air gaps for the experiment sample 2 is equal to 1% of the magnetic path and the total length of the balance magnetic units is equal to 6% of the magnetic path. The total length of the air gaps for the experiment sample 3 is equal to 1% of the magnetic path and the total length of the balance magnetic units is equal to 10% of the magnetic path.

As shown in FIG. 2, when the total length of the balance magnetic unit increases from 3% to 10% of the magnetic path, the reactor becomes more difficult to achieve saturation. That is, it needs larger intensity of magnetic field H to achieve the same magnetic flux density B. At the same time, in view of the B-H curve for experiment sample 3, when the intensity of the magnetic field H is lower, the B-H curve is closed to the B-H curve of the comparing sample 2. When the intensity of the magnetic field H is higher, the B-H curve is closed to the B-H curve of the comparing sample 3. It means that for the reactor utilized the magnetic core with composite air gap, the B-H curve during light load is closed to the B-H curve with 1% air gaps so that it is possible to achieve a higher magnetic permeability. While, the B-H curve during heavy load is closed to the B-H curve with 1.5% air gaps so that the saturation and the decline of the magnetic permeability becomes slower.

In the case of the air gap with the same percentage of the magnetic path, because the magnetic permeability of the balance magnetic unit is far less than that of the planar laminated magnetic material, the initial inductance of the reactor with the magnetic core in this invention (with composite air gap) is lower than that of the reactor with the magnetic core of single material (planar laminated magnetic material).

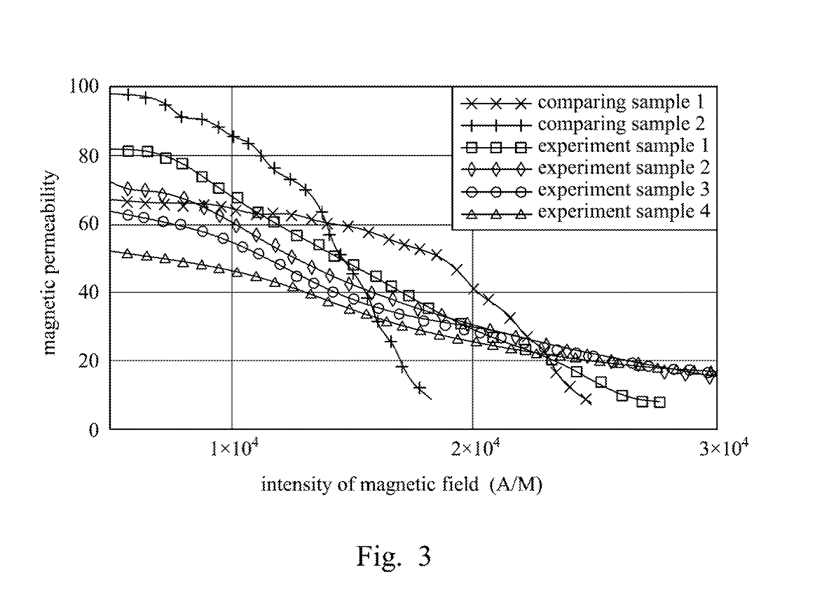

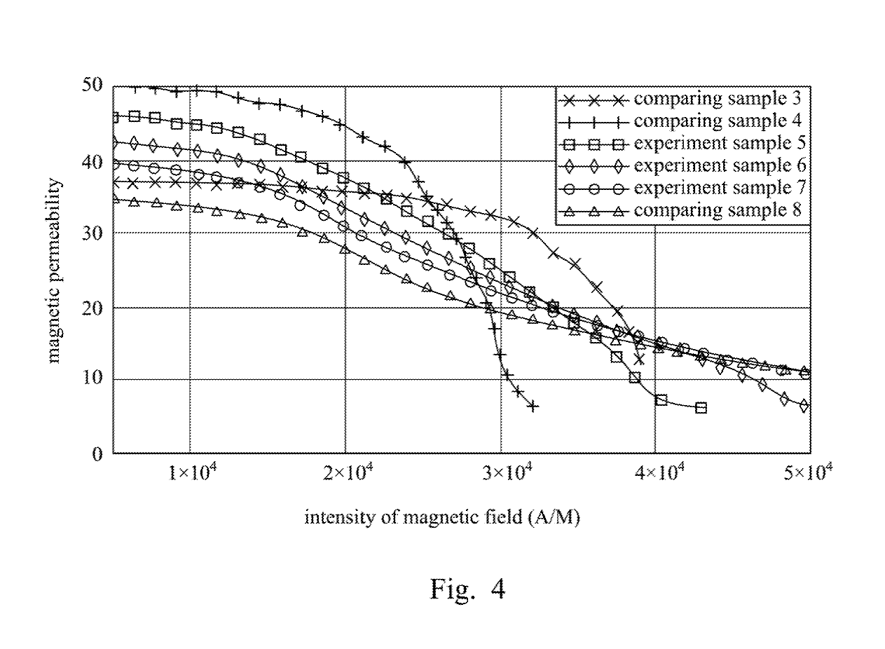

Referring to FIG. 3 and FIG. 4, FIG. 3 and FIG. 4 are curve diagrams showing a magnetic permeability versus intensity of magnetic field (u-H) for the reactor with different magnetic core. In the figures, the horizontal axis shows the intensity of magnetic field H, and the unit is Ampere/Meter (A/M). The vertical axis shows the magnetic permeability, specifically the relative magnetic permeability. The magnetic cores of comparing sample 1-4 are made of the planar laminated magnetic material, that is, the magnetic cores of single material. The total length of the air gaps for the comparing sample 1 is equal to 1.5% of the magnetic path. The total length of the air gaps for the comparing sample 2 is equal to 1% of the magnetic path. The total length of the air gaps for the comparing sample 3 is equal to 3% of the magnetic path. The total length of the air gaps for the comparing sample 4 is equal to 2% of the magnetic path. The magnetic cores of experiment samples 1-8 are the magnetic core with composite air gaps in this invention. The total length of the air gaps for the experiment sample 1 is equal to 1% of the magnetic path and the total length of the balance magnetic units is equal to 10% of the magnetic path. The total length of the air gaps for the experiment sample 2 is equal to 1% of the magnetic path and the total length of the balance magnetic units is equal to 20% of the magnetic path. The total length of the air gaps for the experiment sample 3 is equal to 1% of the magnetic path and the total length of the balance magnetic units is equal to 30% of the magnetic path. The total length of the air gaps for the experiment sample 4 is equal to 1% of the magnetic path and the total length of the balance magnetic units is equal to 50% of the magnetic path. The total length of the air gaps for the experiment sample 5 is equal to 2% of the magnetic path and the total length of the balance magnetic units is equal to 10% of the magnetic path. The total length of the air gaps for the experiment sample 6 is equal to 2% of the magnetic path and the total length of the balance magnetic units is equal to 20% of the magnetic path. The total length of the air gaps for the experiment sample 7 is equal to 2% of the magnetic path and the total length of the balance magnetic units is equal to 30% of the magnetic path. The total length of the air gaps for the experiment sample 8 is equal to 2% of the magnetic path and the total length of the balance magnetic units is equal to 50% of the magnetic path.

As shown in FIG. 3 and FIG. 4, in comparing samples 1-4, the magnetic permeability of the single material magnetic core decreases rapidly after the intensity of the magnetic field exceeds a certain value. For the experiment samples 1-8, when the loading current of the reactor increases gradually, the magnetic permeability of the planar laminated magnetic material and the balance magnetic unit decreases gradually. Then, the inductance begins to decrease slowly. Because the initial magnetic permeability of the balance magnetic unit is far less than that of the planar laminated magnetic material, when the current increases, the balance magnetic unit may share part of the magnetomotive force applied on the planar laminated magnetic material so that the magnetic permeability of the planar laminated magnetic material decreases more slowly. Therefore, the total magnetic permeability of the reactor decreases more slowly.

As shown in FIG. 3 and FIG. 4, because the saturation flux density of the balance magnetic unit is almost the same as that of the planar laminated magnetic material, the situation that some part of the magnetic core reaches saturation state in advance which may cause magnetic permeability of the reactor decreases rapidly could be avoid. Moreover, the larger volume the balance magnetic unit is, the more slowly the magnetic permeability of the reactor decreases.

During light load, the saturation feature of the experiment sample 1 and the experiment sample 2 is closed to the comparing sample 2, while the heavy load feature thereof is closed to the comparing sample 1. Similarly, during light load, the saturation feature of the experiment samples 5, 6 and 7 is closed to the comparing sample 4, while the heavy load feature thereof is closed to the comparing sample 3. From the results of the experiment, it is approved that the magnetic core has balanced performance in inductance for light load and heavy load.

However, not the volume of the balance magnetic unit inserted into the magnetic core of composite material larger must be better. As shown in FIG. 3 and FIG. 4, for the air gap, when too much volume of the balance magnetic unit is inserted as the experiment samples 4 and 8, the saturation curve becomes more smooth, but the initial magnetic permeability of the magnetic core becomes too low, so as the magnetic permeability in the whole load operation region. Therefore, the improvement of inductance for the light load becomes not obvious and useless in application. Accordingly, when the thickness of the balance magnetic unit in the composite air gap is less than twenty times of the thickness of the air gap, the balanced performance in inductance for the light load and the heavy load may be achieved.

Referring back to FIG. 1, the magnetic core 100 not only has the advantages of small volume and the balance performance of light load and heavy load, but also could help to reduce eddy loss. The advantage will be described as below.

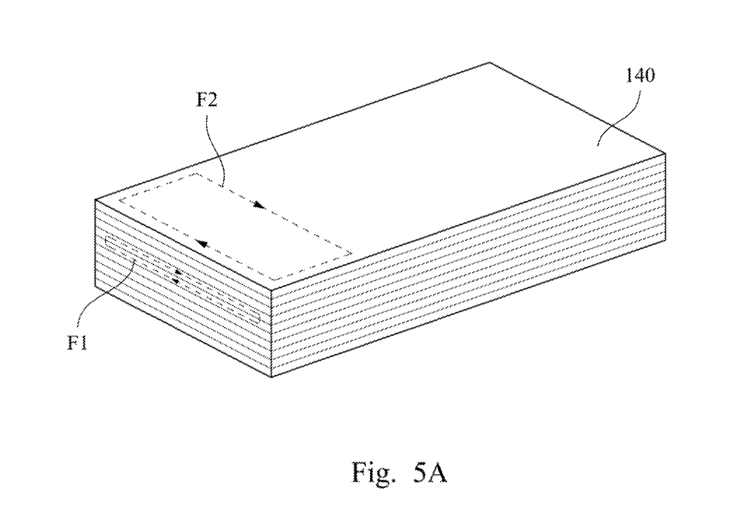

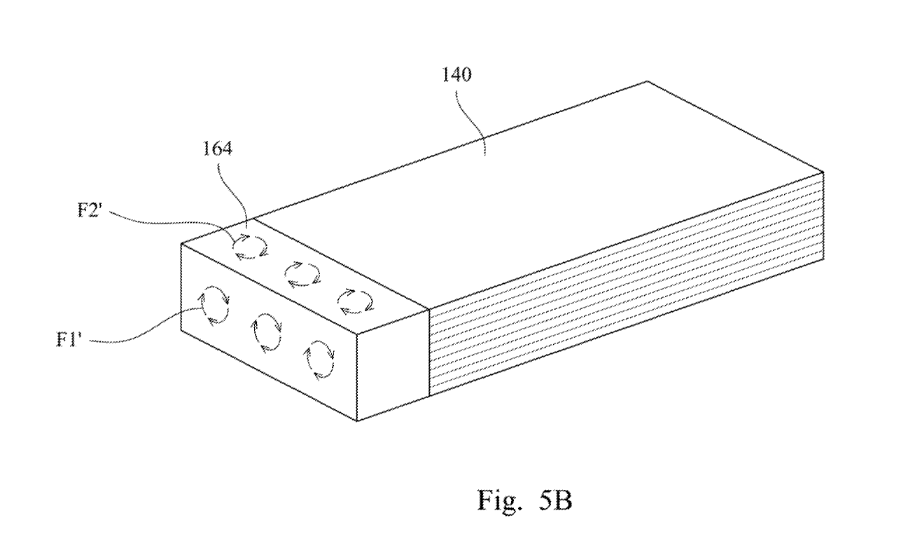

Referring to FIG. 5A and FIG. 5B, FIG. 5A is a schematic view of the magnetic flux for the core column of the planar laminated magnetic material 140. FIG. 5B is a schematic view of the magnetic flux for the core column of the planar laminated magnetic material 140 with a balance magnetic unit 164.

Usually, the planar laminated magnetic material 140 has high magnetic permeability. In other words, when this material is utilized in the reactor, the magnetic core may be saturated by a relative small current. In order to improve the anti-saturation ability of the reactor, the air gap is disposed in the magnetic core. Usually, the size of the air gap is controlled to restrain the coil loss affected by the flux diffusion of the air gap. Although plural air gaps distributed on each core columns may reduce the coil loss, it brings the negative effect on the loss of the magnetic core. As shown in FIG. 5A, the magnetic core plane in which the major flux F1 flows consists of plural planar laminated magnetic material 140 which are stacked and isolated each other. Thus, large eddy current may not occur in the plane. The magnetic core plane in which the diffusion flux F2 flows is an integrated plane, a large eddy current may be induced in the plane so that the additional eddy loss is generated. The effect of the eddy loss is significant. Usually, the additional eddy loss caused by cutting of the diffusion flux may be twice as high as the magnetic core loss in normal operation of the reactor.

As shown in FIG. 5B, because the balance magnetic unit 164 is disposed into the magnetic core in this invention, the eddy loss is restrained effectively. One kind of explanation for the above conclusion is illustrated here. Referring to the FIG. 5B, the major magnetic flux F1′ and the diffusion magnetic flux F2′ substantially flows the balance magnetic unit 164 which is made of the core block of metal powder. Because the particles in the core block of metal powder are very small, the generation of the eddy current is restrained effectively. Accordingly, the risk of deterioration of the directional eddy current is eliminated so that the additional eddy loss from the cutting of the diffusion flux. F2 as shown in FIG. 5A could be reduced.

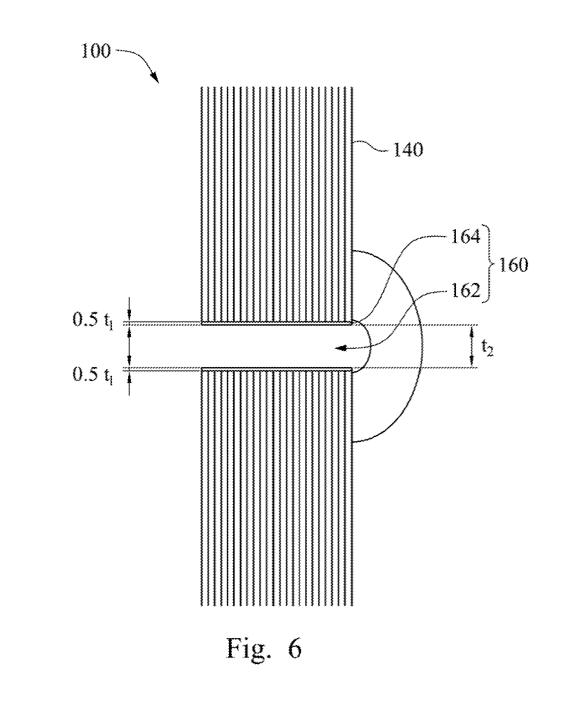

Referring to FIG. 6, FIG. 6 is partial enlarged view of magnetic core according to one embodiment of this invention. Each of the composite air gaps 160 includes two balance magnetic units 164 and an air gap 162. The balance magnetic units 164 are arranged at the opposite sides of the air gap 162 respectively. The thicknesses of the two balance magnetic units are the same so that the composite air gap 160 is a symmetric structure. The thickness t1 in this embodiment is the summation thicknesses of both balance magnetic unit 164. Thus, the thickness of each of the balance magnetic units 164 is 0.5 t1. The thickness of the air gap is t2.

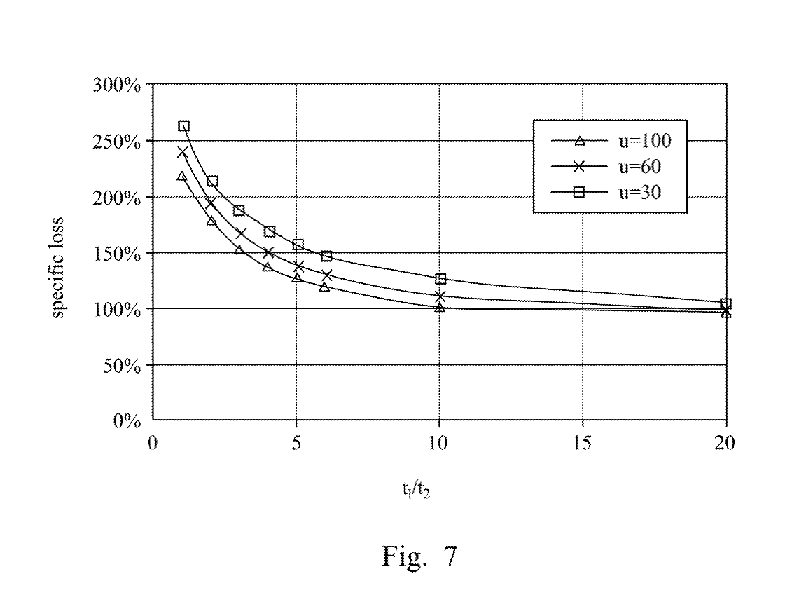

Referring to FIG. 7, FIG. 7 is specific loss diagram showing the magnetic cores with the balance magnetic unit of different ratio. Among the magnetic cores of the reactor, at least one magnetic core is the first core column with the composite air gap. For example, in FIG. 7, the magnetic core has two core columns: one is the first core column with the composite air gap; the other core column is made of planar laminated magnetic material. The composite air gap of the first core column is the same as shown in FIG. 6, but the thickness ratio of the balance magnetic unit and air gap may be different. In FIG. 7, the horizontal axis represents the thickness ratio of the balance magnetic unit and air gap and the vertical axis represents the specific loss. The specific loss is the ratio of the magnetic core loss with the balance magnetic unit of different ratio and the magnetic core loss with planar laminated magnetic material. The greater the value of the specific loss is, the greater the additional eddy loss is. The value 100% represents no additional eddy loss relative to the conventional magnetic core of the planar magnetic material without air gap.

As shown in FIG. 7, when the ratio of the thickness t1 of the balance magnetic unit and the thickness t2 of the air gap, that is, the thickness ratio t1/t2 is 4 or above, the eddy loss of the planar laminated magnetic material is restrained effectively. The effect is similar for the balance magnetic unit with the magnetic permeability of 100, 60 or 30. More particularly, when the thickness ratio t1/t2 is ten or above, the additional eddy loss may be ignored compared to loss of the magnetic core made by the planar magnetic material without air gap.

Therefore, the thickness ratio between the balance magnetic unit and the air gap is preferably from 4 to 20 so that the eddy current is well restrained.

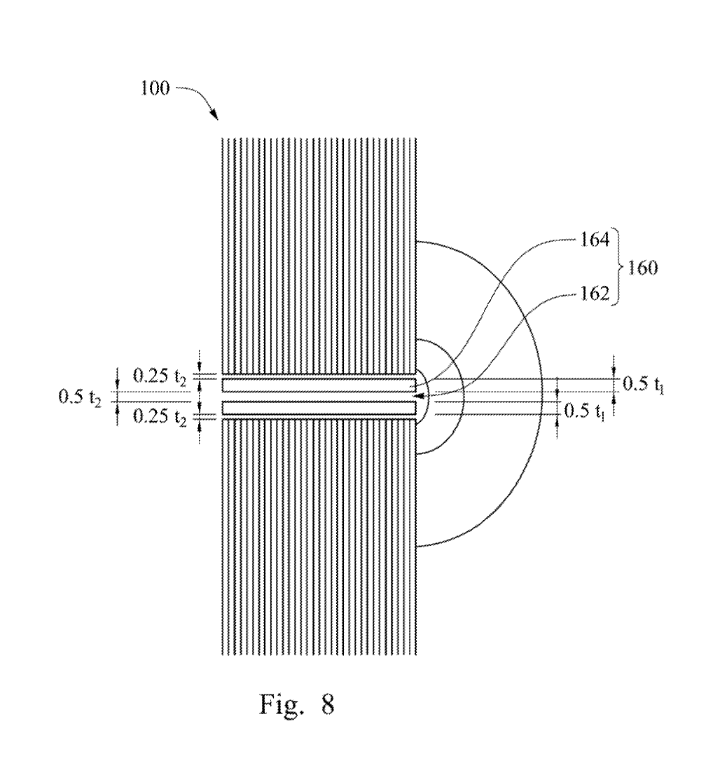

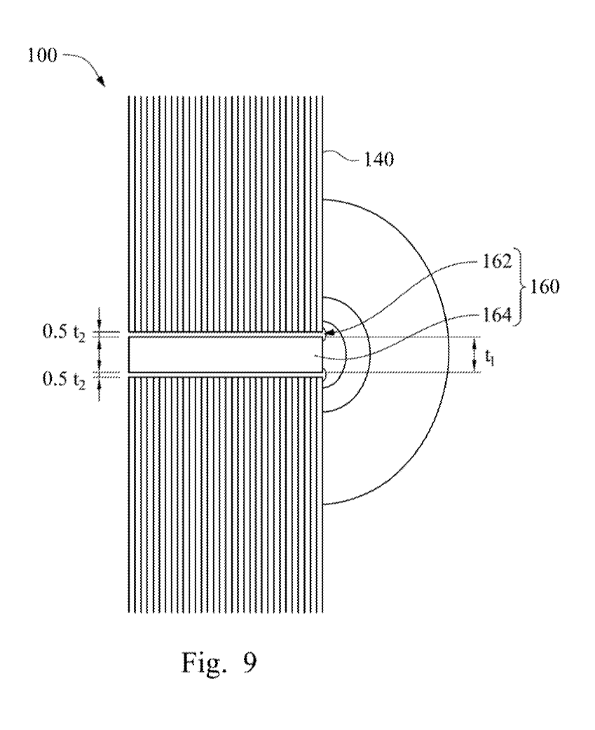

FIG. 8 and FIG. 9 are partial enlarged views of the magnetic core according to different embodiments of this invention. As shown in FIG. 8, each of the composite air gaps 160 includes two balance magnetic units 164 and three air gaps 162. Two balance magnetic units 164 are disposed among three air gaps 162. The balance magnetic unit 164 and air gaps 162 are arranged alternatively so that the composite air gap 160 is a symmetric structure. In every composite air gap 160, the thickness t1 of the balance magnetic unit 164 is along the direction of the magnetic path. The thickness t2 of the air gap is along the direction of the magnetic path. For more specific, the thickness of each of the balance magnetic units 164 is 0.5 t1 in this embodiment. The thickness of the air gap 162 between two balance magnetic units 164 is 0.5 t2. The thickness of the air gap 162 located at the outer sides of the balance magnetic units 164 is 0.25 t2.

As shown in FIG. 9, each of the composite air gaps 160 includes a balance magnetic unit 164 and two air gaps 162. The air gaps 162 are disposed at the opposite sides of the balance magnetic units 164 so that the composite air gap 160 is a symmetric structure. In every composite air gap 160, the thickness t1 of the balance magnetic unit 164 is along the direction of the magnetic path. The thickness t2 of the air gap is along the direction of the magnetic path. The thickness of the air gap 162 located at the opposite sides of the balance magnetic units 164 is 0.5 t2.

In FIG. 8 and FIG. 9, because the balance magnetic units 164 are inserted, the area of the planar laminated magnetic material cut by the diffusion magnetic flux is reduced. Moreover, in FIG. 8 and FIG. 9, the air gap is divided into two air gaps 162, and the eddy loss is restrained more effectively.

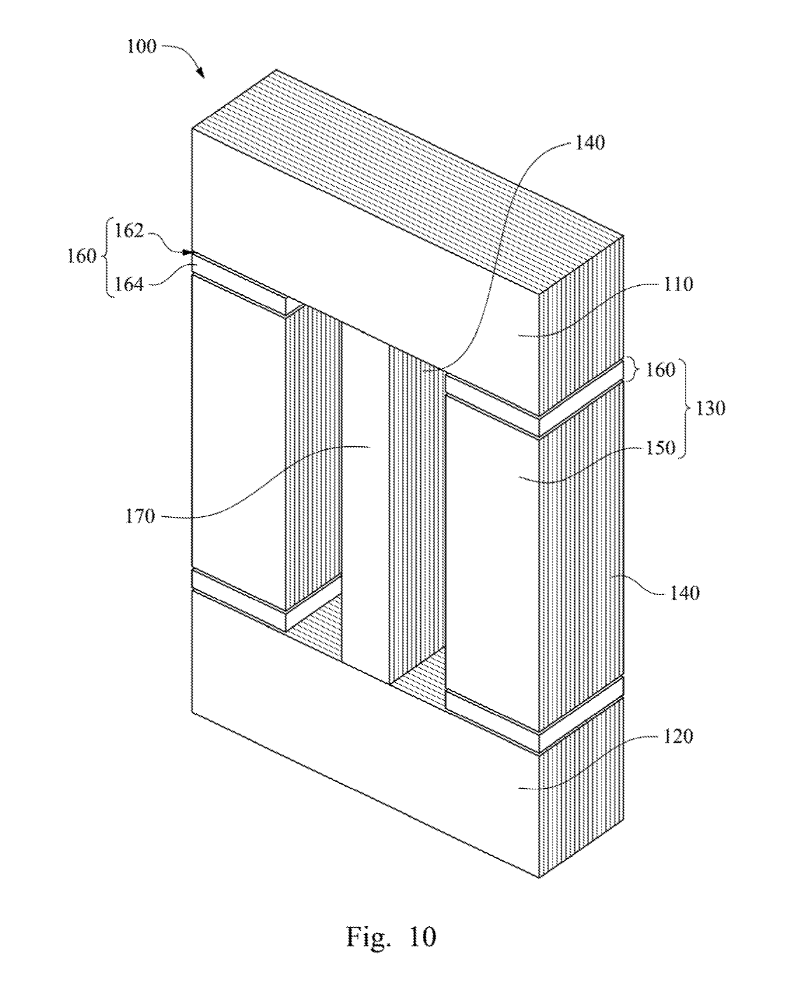

Referring to FIG. 10, FIG. 10 is a schematic view of the magnetic core according to another embodiment of this invention. The magnetic core 100 includes at least two core columns, the upper yoke 110 and the bottom yoke 120. The core columns include the first core column 130 with the composite air gap 160 and the second core column 170. The second core column 170 is connected to the upper yoke 110 and the bottom yoke 120. The second core column 170 is made of the planar laminated magnetic material 140. As described above, the planar laminated magnetic material 140 may be amorphous alloy, nano-crystalline alloy, permalloy, silicon steel lamination or super silicon steel lamination. The part of the magnetic core made by the planar laminated magnetic material is made by cutting a wounded thin alloy belt. Alternatively, the part of the magnetic core made by the planar laminated magnetic material is made by cutting the alloy laminations and laminating them.

In this embodiment, the magnetic core 100 includes two first core columns 130 and a second core column 170. The second core column 170 is disposed between two first core columns 130. The cross-sections of both the first core column 130 and the second core column 170 are rectangular. As shown in FIG. 10, the cross-section area of the second core column 170 is smaller than that of the first core column 130.

The magnetic core 100 of this invention may combine with a coil and be utilized in a reactor, for example, single phase reactor, double way integrated reactor, three phase reactor, three phases and five columns reactor and so on. The magnetic core of this invention may achieve two objects of small volume and less loss. Reference will now be made in detail to the present embodiments of the invention as below.

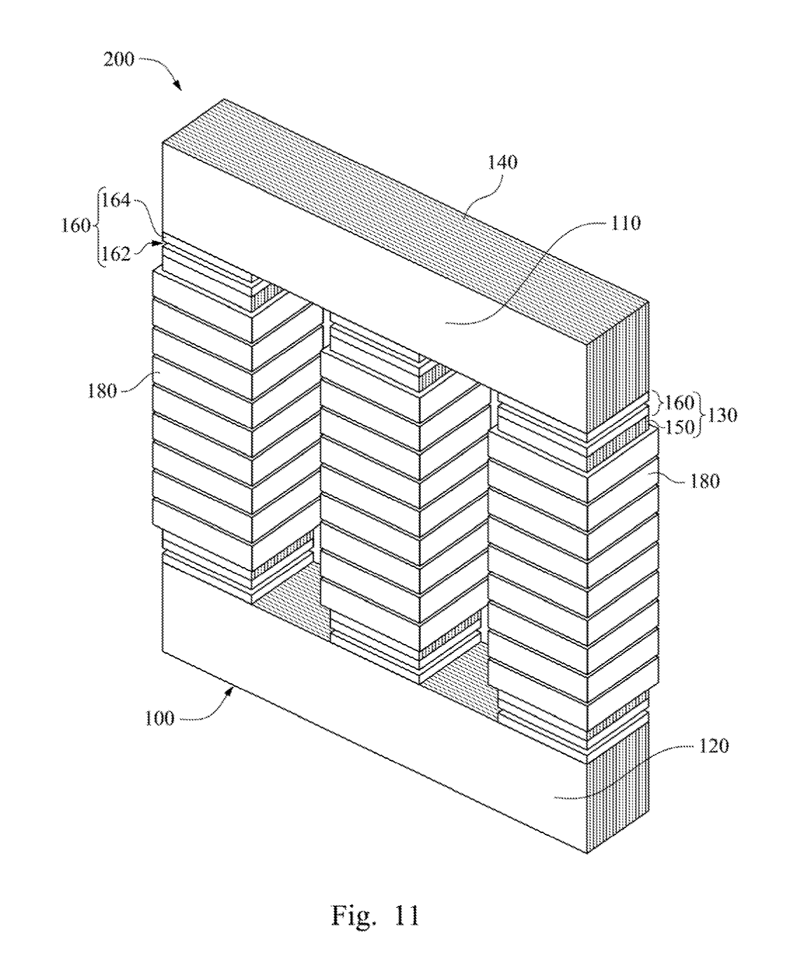

Referring to FIG. 11, FIG. 11 is a schematic view of the reactor with the magnetic core according to one embodiment of this invention. The reactor 200 includes the magnetic core 100 and the coil 180. The magnetic core 100 includes the upper yoke 110, the bottom yoke 120 and plural first core columns 130 with the composite air gaps 160. The coil is wound on the first core columns 130. With respect to the rectangular cross-section of the first core columns 130, the coil 180 is preferably a square wire.

In fact, the reactor 200 of this embodiment is a three phase reactor and the magnetic core 100 is utilized in the reactor 200. The reactor 200 includes three first core columns 130 with the composite air gaps 160, three coils 180 wound on the first core columns 130, the upper yoke 110 and the bottom yoke 120 made of the planar laminated magnetic material 140. Each of the first core columns 130 includes three composite air gaps 160. The composite air gaps 130 are distributed on the first column 130 uniformly.

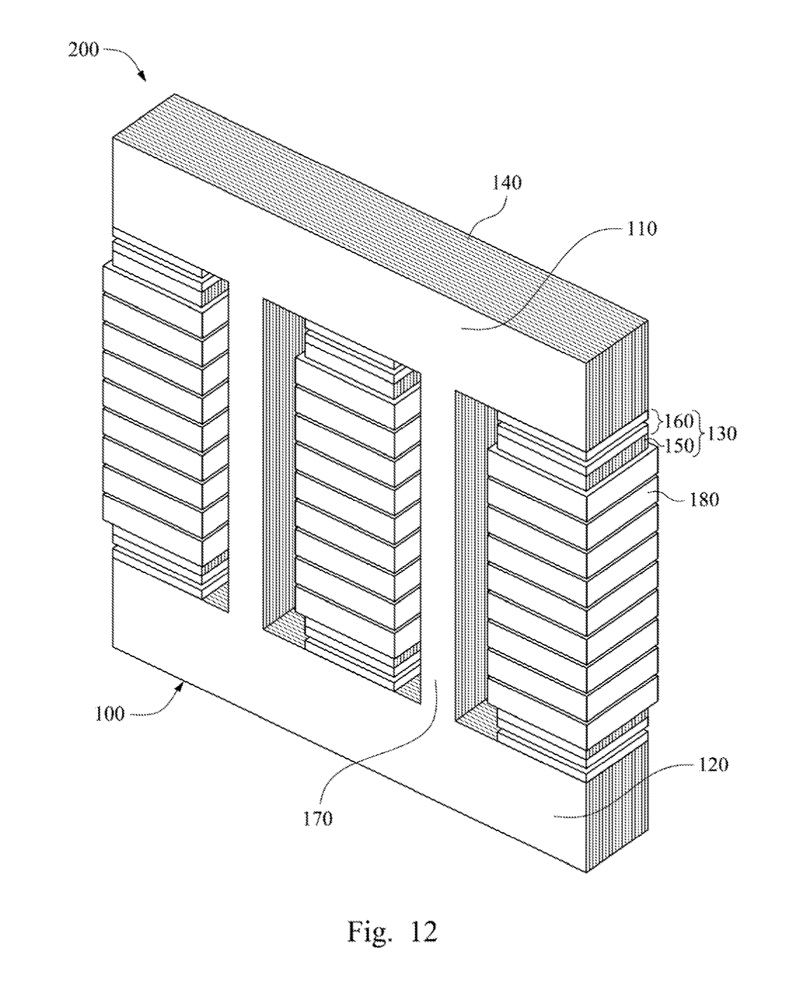

Referring to FIG. 12, FIG. 12 is a schematic view of the reactor with the magnetic core according to another embodiment of this invention. The reactor 200 is a three phases and five columns reactor and the magnetic core 100 is utilized in the reactor 200. Comparing with the previous embodiment, the reactor 200 of this embodiment further includes two second core columns 170. The second core columns 170 are made of the planar laminated magnetic material 140 and without the coil 180.

The magnetic core 100 and the coil 180 may be dipped in the paint and baked and solidified together. Accordingly, the structure of the magnetic core 100 is fixed and the magnetic core 100 is combined with the coil 180.

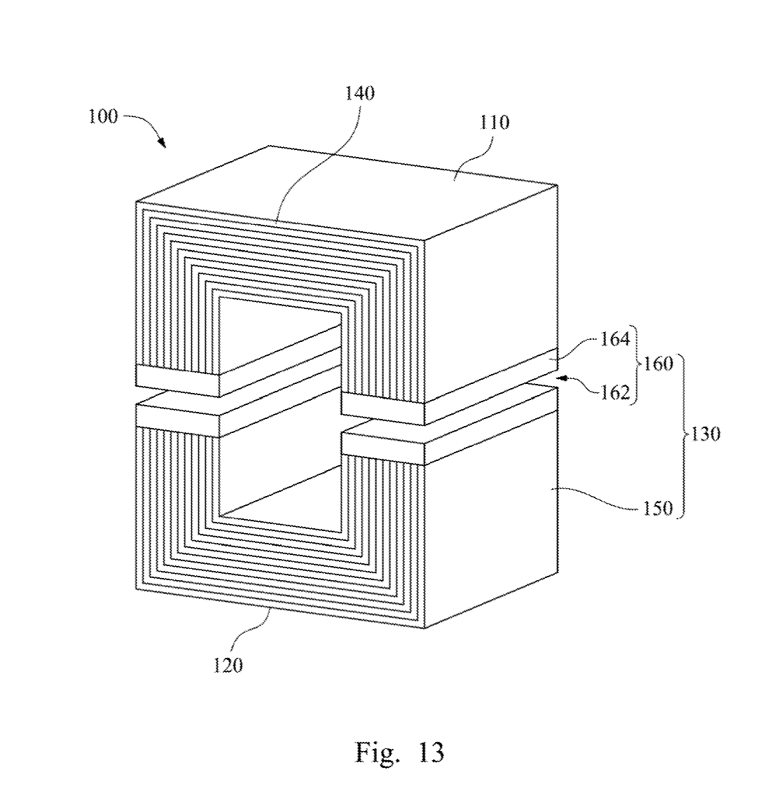

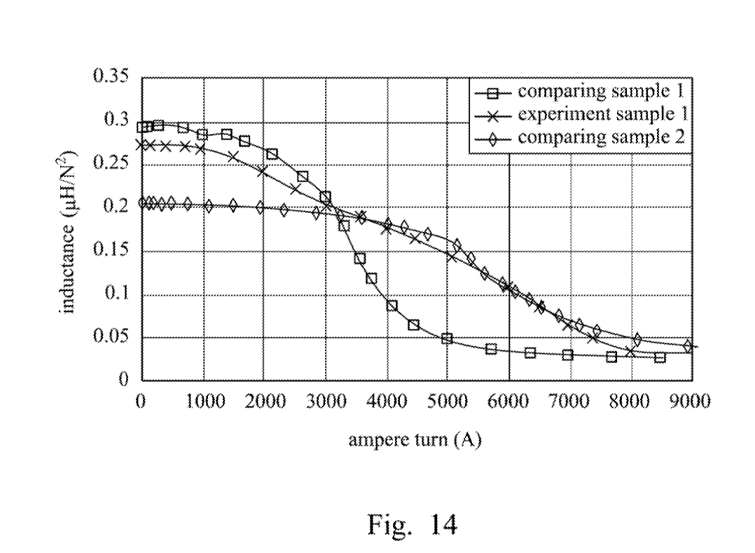

The reactor 200 with the magnetic core 100 may reduce the volume and balance the inductance for the light and heavy load effectively. Referring to FIG. 13 and FIG. 14, FIG. 13 is a schematic view of the magnetic core according to further another embodiment of this invention; FIG. 14 is a diagram showing inductance versus the ampere-turn for the conventional reactor with the magnetic core of single material and the reactor in FIG. 13

For example, the specifications of the reactor are: initial inductance with single ampere turn is more than 0.26 μH and the decrease inductance with maximum ampere turns 5000 is less than 50%. In comparing sample 1, the magnetic core is made of the planar laminated magnetic material with the air gap of 2 mm. The initial inductance with single ampere-turn is about 0.29 μH and matches the specification. However, the inductance with the maximum ampere-turns 5000 is merely 0.05 μH and out of specification. In comparing sample 2, the magnetic core is made of the planar laminated magnetic material with the air gap of 4 mm. The initial inductance with single ampere-turn is about 0.2 μH and out of the specification. However, the inductance with the maximum ampere-turns 5000 is 0.16 μH and matches the specification. In other words, if the technology of the magnetic core in this invention is not utilized, the only way to match the specifications is to increase the volume of the magnetic core. On the other hand, the initial magnetic core loss of this reactor is about 9 W/kg, wherein the frequency is 20 KHz and the magnetic flux density is 0.1 T. In the same operation state, when the air gap is 2 mm, the magnetic core loss is more than 20 W/Kg because of the additional eddy loss from the diffusion magnetic flux of the air gap. When the air gap is 4 mm, the magnetic core loss become too large to use.

In experiment sample 1, the magnetic of this invention is utilized in the reactor. As shown in FIG. 13, two first core columns 130 of the magnetic core 100 are configured with a composite air gap 160. The thickness of the air gap 162 in every composite air gaps 160 is 2 mm. The balance magnetic units 164 of thickness 4 mm are disposed on the upper side and bottom side of the air gap 162. The initial magnetic permeability of the balance magnetic unit 164 is 60. The thickness of the balance magnetic unit 164 is four times of that of the air gap 162. In experiment sample 1, the inductance with single ampere-turn is 0.27 μH and the inductance with the maximum ampere-turns 5000 is 0.15 μH so that the specifications of the initial inductance and the decrease in the inductance are satisfied simultaneously. The magnetic core of this invention may reduce the additional eddy loss of the diffusion magnetic flux effectively. In this operation state, the magnetic core loss may be controlled under 14 W/Kg. As mentioned above, this invention may achieve two objects of reducing the volume and the loss.

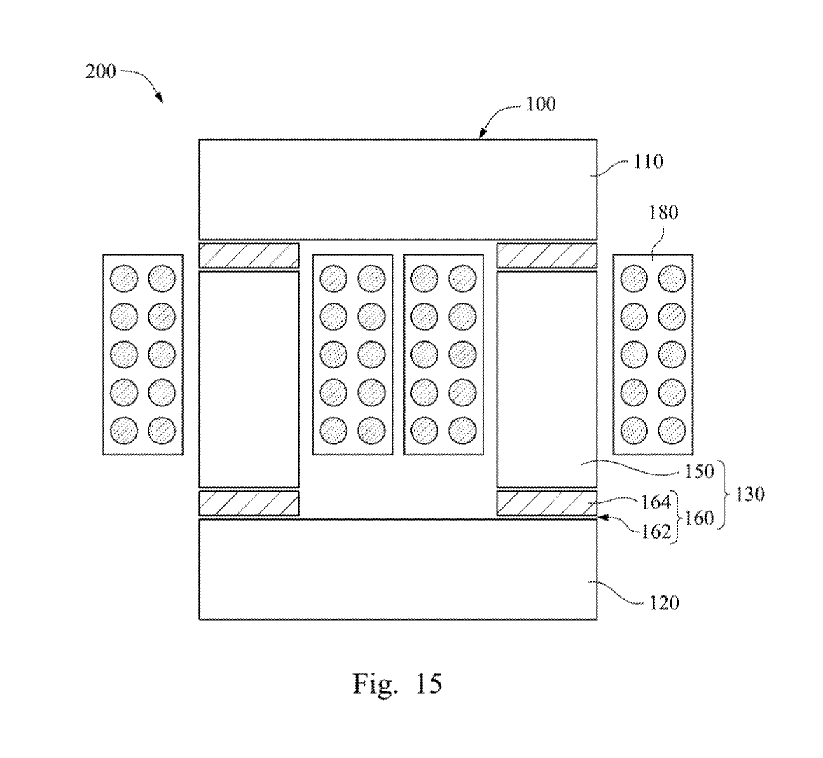

Another application for the magnetic core of this invention is the power factor correction (PFC) inductor which is utilized in the home solar inverter with power of 3 kW. The initial inductance is not less than 1.3 mH and the decrease of inductance is less than 50 percentage at the rating current 18 A. As shown in FIG. 15, the upper yoke 110 and the bottom yoke 120 of the magnetic core 100 are made of the planar laminated magnetic material (nanocrystalline of iron). The core body 150 of the first core column 130 is also made of the planar laminated magnetic material (nano crystalline of iron). The balance magnetic unit 164 of the first core column 130 is made of Al—Si—Fe alloy powder core. The coil 180 is made of 2.5 mm enameled round copper wire and wound 54 turns. Each of the first core columns 130 includes two composite air gaps 160 disposed on the top end and the bottom end of the first core column 130. In every composite air gaps, the thickness of the air gap 162 is 0.3 mm and the thickness of the balance unit 164 is 2 mm, that is, 6.67 times of the air gap thickness. The size of the reactor in this solution is 75 mm*56 mm*86 mm. The initial inductance is 1.36 mH and the inductance with the rating current 18 A is about 0.8 mH. The DC resistance of the coil 180 is 28 mΩ. In the operation conditions of 20 kHz, 20 mT, the magnetic core loss is about 620 mW. Under the same specifications, with respect to the conventional reactor of stacked block cores of metal powder, the volume of the reactor 200 is about 48.7% of the conventional one. The DC resistance of the coil 180 is about 87.5% of the conventional one. The magnetic core loss is about 95.3% of the conventional one. Accordingly, the advantage of this invention is significant. Therefore, as mentioned above, when the reactor of this invention is operated in high power application (higher than 3 kW), the advantages of volume (smaller) and efficiency are significant.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A magnetic core utilized in a reactor, comprising:
an upper yoke;
a bottom yoke; and
at least two core columns comprising at least one first magnetic column, wherein the first magnetic column includes a core body, a balance magnetic unit and an air gap, wherein the balance magnetic unit and the adjacent air gap form a composite air gap for dividing the core body into different parts;
wherein the upper yoke, the bottom yoke, and the two core columns essentially constitute a closed magnetic loop, wherein the upper yoke, the bottom yoke, and the core body are made of planar laminated magnetic material, and wherein the magnetic permeability of the balance magnetic unit is lower than the magnetic permeability of the planar laminated magnetic material.

2. The magnetic core of claim 1, wherein the initial magnetic permeability of the balance magnetic unit is not greater than one twentieth of that of the planar laminated magnetic material.

3. The magnetic core of claim wherein the balance magnetic unit is a kind of block core of metal powder.

4. The magnetic core of claim 3, wherein the material of the block core of metal powder is ferrosilicon, Al—Si—Fe alloy, ferronickel alloy, nickel-molybdenum iron, amorphous alloy, nano-crystalline alloy, or silicon steel lamination.

5. The magnetic core of claim 1, wherein the ratio of the thickness of the balance magnetic unit and the thickness of the air gap is essentially in the range of 4 to 20.

6. The magnetic core of claim 1, wherein the quantity of the balance magnetic units in each of the composite air gaps is one or two.

7. The magnetic core of claim 6, wherein the balance magnetic units or the balance magnetic unit is symmetrically arranged according to the center line of the composite air gap.

8. The magnetic core of claim 1, further comprising a magnetic isolated material filled in the air gap, wherein the magnetic permeability of the magnetic isolated material is one.

9. The magnetic core of claim 1, wherein the planar laminated magnetic material is amorphous alloy, nano-crystalline alloy, permalloy, silicon steel lamination or super silicon steel lamination.

10. The magnetic core of claim 1, wherein the upper yoke, the bottom yoke, and the core body are made by winding and cutting a thin alloy belt.

11. The magnetic core of claim 1, wherein the upper yoke, the bottom yoke, and the core body are made by cutting and laminating a thin alloy belt.

12. The magnetic core of claim 1, wherein the composite air gaps are plural and uniformly distributed on the first magnetic column.

13. The magnetic core of claim 1, wherein the two core columns are both the first magnetic columns.

14. The magnetic core of claim 1, wherein the cross-section of the first magnetic column is rectangular.

15. The magnetic core of claim 1, wherein the core columns include a second magnetic column and wherein the cross-section area of the second magnetic column is smaller than that of the first magnetic column.

16. The magnetic core of claim 15, wherein the second magnetic column is made of planar laminated magnetic material.

17. A reactor, comprising the magnetic core of claim 1 and a coil wound on the magnetic core, wherein the coil is wound on the first magnetic column.

18. The reactor of claim 17, wherein the coil is a square wire.
